(19) United States
(12) Patent Application Publication
(10) Pub. No.: US 2010/0091395 A1
(43) Pub. Date: Apr. 15, 2010

(54) CORE MODULE WITH MULTIPLE LAYERS AND A WATER FILTER WITH THE CORE MODULE

(76) Inventor: Ching-Heng HUANG, Yonghe City (TW)

Correspondence Address: Rahman LLC, 10025 Governor Warfield Parkway, Suite 110, Columbia, MD, 21044, US

(21) Appl. No.: 12/248,298

(22) Filed: Oct. 9, 2008

(51) Int. Cl. G02B 5/08

(52) U.S. Cl. 359/850

(57) ABSTRACT

A core module for a water filter with multiple layers has an outer filtering barrel, an activated carbon rod and an inner filtering barrel. The activated carbon rod is mounted in a central channel of the outer filtering barrel. The inner filtering barrel is mounted in a central channel of the activated carbon rod. When the water is filtrated, the water flows through the outer filtering barrel, the activated carbon rod and the inner filtering barrel in sequence. When the activated carbon particles are dropped from the activated carbon rod, the inner filtering barrel blocks the activated carbon particles to keep the activated carbon particles from flowing out with the water. Therefore, the filtering water is kept clean.

### BACKGROUND OF THE INVENTION

1. Field of the Invention

The present invention relates to a core module with multiple layers for a water filter, especially to a core module for a water filter that connects to a water tube to filtrate water.

2. Description of the Prior Arts

To keep the water clean and unpolluted, water filters are widely used to connect between the water tube and the faucet to filtrate the water. The water filters get rid of impurities and pernicious substances in the water, and then the user may boil the water to drink.

The conventional water filter comprises a conventional core module. The conventional core module for the conventional water filter has a filtering barrel and an activated carbon rod. The activated carbon rod is mounted in the filtering barrel and has an axial central channel. When conventional water filter filtrate water, the water flows through the filtering barrel and permeates into the activated carbon rod. Then the water flows into the axial central channel of the activated carbon rod and flows out of the conventional core module. The filtering barrel blocks the larger particles of the impurities in the water. The other impurities and the pernicious substances in the water are adsorbed in the activated carbon rod. Therefore, the water is kept clean and unpolluted.

However, the activated carbon rod consists of numerous activated carbon particles. The activated carbon particles easily fall off and drop into the water. Therefore, the black activated carbon particles pollute the filtering water.

To overcome the shortcomings, the present invention provides a core module with multiple layers for a water filter to mitigate or obviate the aforementioned problems.

### SUMMARY OF THE INVENTION

The main objective of the present invention is to provide a core module for a water filter with multiple layers. The core module has an outer filtering barrel, an activated carbon rod and an inner filtering barrel. The activated carbon rod is mounted in a central channel of the outer filtering barrel. The inner filtering barrel is mounted in a central channel of the activated carbon rod. When the water is filtrated, the water flows through the outer filtering barrel, the activated carbon rod and the inner filtering barrel in sequence. When the activated carbon particles are dropped from the activated carbon rod, the inner filtering barrel blocks the activated carbon particles to keep the activated carbon particles from flowing out with the water. Therefore, the filtering water is kept clean.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a core module with multiple layers in accordance with the present invention;

FIG. 2 is an exploded perspective view of the core module in FIG. 1;

FIG. 3 is a side view in partial section of the core module in FIG. 1;

FIG. 4 is a perspective view of a water filter in accordance with the present invention;

FIG. 5 is an exploded perspective view of the water filter in FIG. 4; and

FIG. 6 is a side view in partial section of the water filter in FIG. 4.

### DETAILED DESCRIPTION OF THE PREFERRED EMBODIMENTS

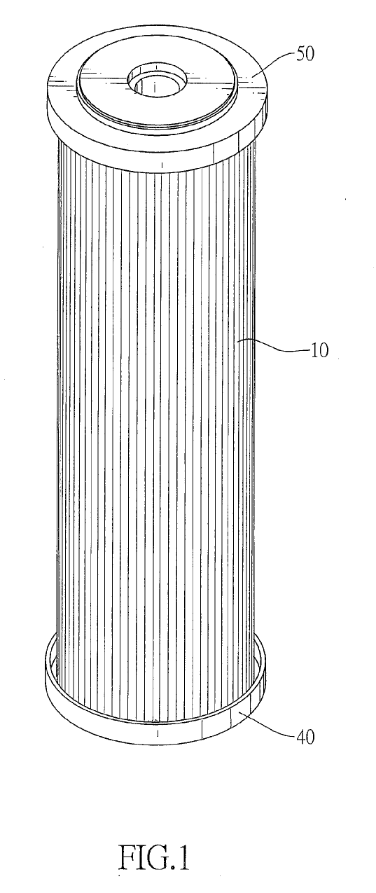

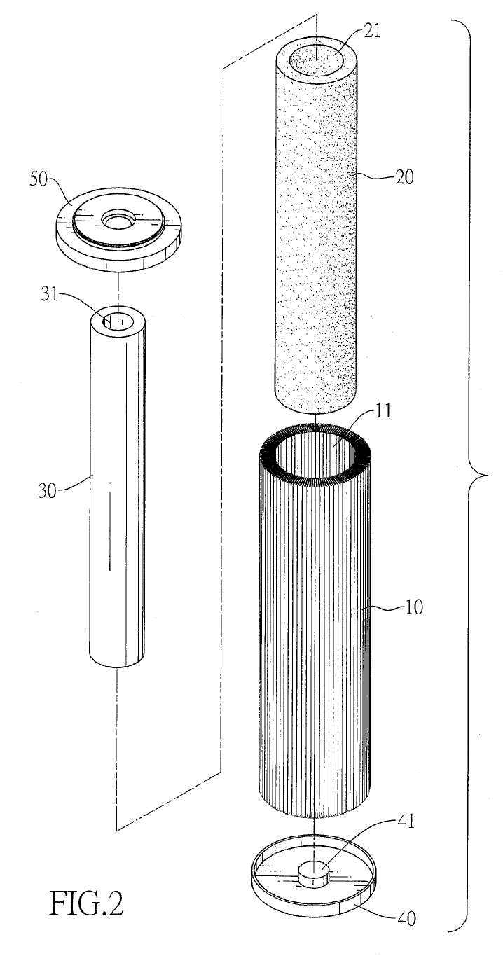

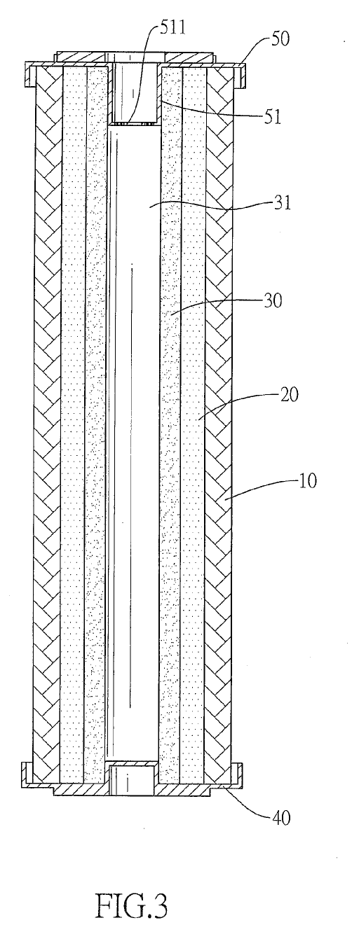

With reference to FIGS. 1 to 3, a core module for a water filter with multiple layers in accordance with the present invention comprises an outer filtering barrel (10), an activated carbon rod (20), an inner filtering barrel (30), a base (40) and a cover (50).

The outer filtering barrel (10) has a length, a top end, a bottom end and a central channel (11) being formed axially through the outer filtering barrel (10). The outer filtering barrel (10) may be made of non-woven fiber or melt-blown and may be pleated.

The activated carbon rod (20) is mounted in the central channel (11) of the outer filtering barrel (10) and has a length, a top end, a bottom end and a central channel (21) being formed axially through the activated carbon rod (20).

The inner filtering barrel (30) is mounted in the central channel (21) of the activated carbon rod (20) and has a length, a top end, a bottom end and a central channel (11) being formed axially through the inner filtering barrel (30). The inner filtering barrel (30) maybe made of non-woven fiber or melt-blown and may be pleated. The lengths of the outer filtering barrel (10), the activated carbon rod (20) and the inner filtering barrel (30) are the same.

The base (40) covers and seals the bottom ends of the outer filtering barrel (10), the activated carbon rod (20) and the inner filtering barrel (30) and has a top surface and a lower plug (41). The lower plug (41) is formed axially on the top surface of the base (40) and protrudes into the central channel (31) of the inner filtering barrel (30).

The lid (50) covers the top ends of outer filtering barrel (10), the activated carbon rod (20) and the inner filtering barrel (30) and has a bottom surface and an upper plug (51). The upper plug (51) is formed axially on the bottom surface of the lid (50), protrudes into the central channel (31) of the inner filtering barrel (30) and has a central hole (511). The central hole (511) of the upper plug (51) communicates with the central channel (31) of the inner filtering barrel (30).

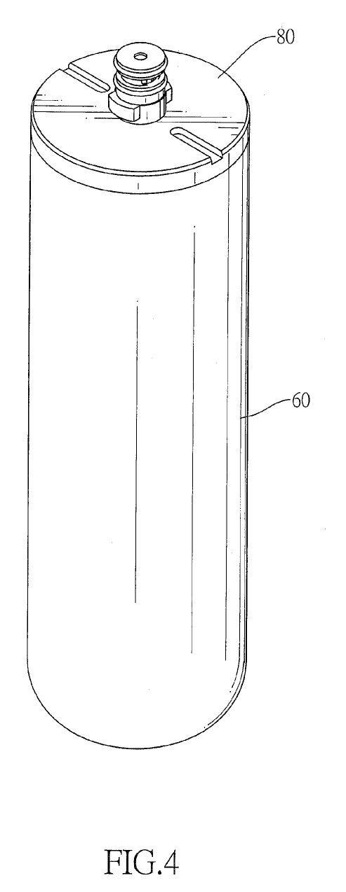

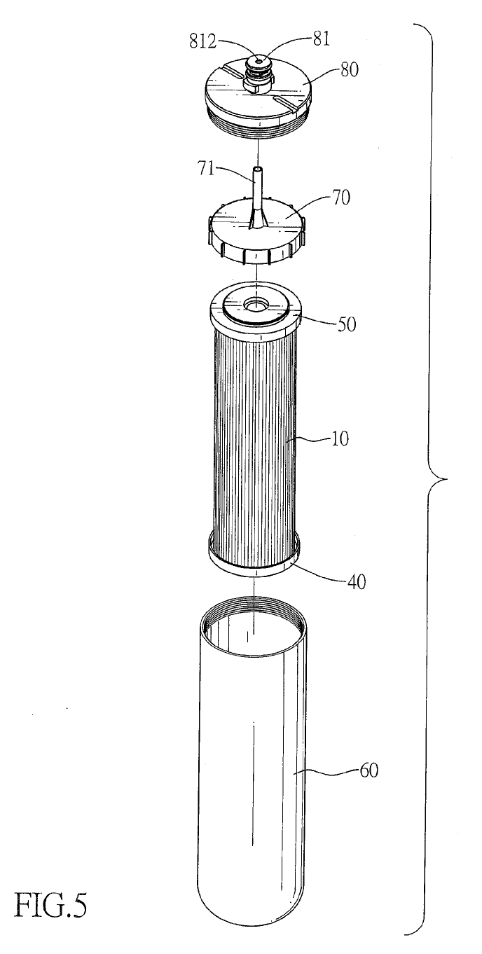

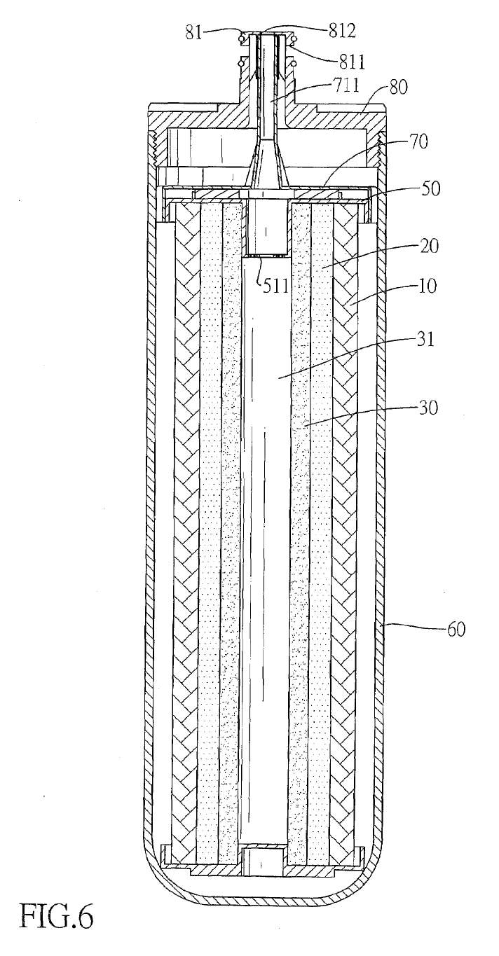

With further reference to FIGS. 4 to 6, a water filter in accordance with the present invention comprises a shell (60), a core module as described, an inner cap (70) and an outer cap (80).

The shell (60) is hollow and has a top opening and an inner wall. The core module as described is mounted in the shell (60) through the top opening of the shell (60). The lid (50) of the core module as described corresponds to the top opening of the shell (60).

The inner cap (70) is mounted on a top end of the core module, covers the lid (50), is disconnected to the inner wall of the shell (60) to form an interval and has a top surface and a nozzle (71). The nozzle (71) is formed axially on the top surface of the inner cap (70), corresponds to the upper plug (51) of the lid (50) and has a central water passage (711). The central water passage (711) is formed axially through the nozzle (71) and communicates with the central hole (511) of the upper plug (51) and the central channel (31) of the inner filtering barrel (30).

The outer cap (80) is mounted on and covers the top opening of the shell (60), is mounted around the nozzle (71) of the inner cap (70) and has a top surface and a connector (81). The connector (81) is hollow, is formed on the top surface of the outer cap (80), is mounted around the nozzle (71) and has a top end, a sidewall, at least one outlet (811) and an inlet (812). The at least one outlet (811) is formed through the sidewall of the connector (81). The inlet (812) is formed through the top end of the connector (81) and communicates with the water passage (711) of the nozzle (71).

When the water filter as described filtrates water, the water flows through the inlet (811) of the connector (81) and flows into the shell (60). The water then flows through the interval between the inner cap (70) and flows into the outer filtering barrel (10). The water flows through the outer filtering barrel (10), the activated carbon rod (20) and the inner filtering barrel (30) in sequence to finish filtration. Subsequently, the filtering water flows into the central channel (31) of the inner filtering barrel (30), flows through the central hole (511) of the upper plug (51) and the water passage (711) of the nozzle (71) and flows out of the outlet (811) of the connector (81).

With the inner filtering barrel (30), the dropped particles of the activated carbon rod (20) are blocked by the inner filtering barrel (30). Then, the dropped particles do not flows out of the water filter as described with the filtering water. Therefore, the water filtrated by the water filter as described is kept clean.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A core module for a water filter comprising:
an outer filtering barrel having a top end;
a bottom end; and
a central channel being formed axially through the outer filtering barrel;
an activated carbon rod being mounted in the central channel of the outer filtering barrel and having a top end;
a bottom end; and
a central channel being formed axially through the activated carbon rod; and
an inner filtering barrel being mounted in the central channel of the activated carbon rod and having a top end;
a bottom end; and
a central channel being formed axially through the inner filtering barrel.

2. The core module as claimed in claim 1, further comprising:
a base covering and sealing the bottom ends of the outer filtering barrel,
the activated carbon rod and the inner filtering barrel; and
a lid covering the top ends of outer filtering barrel, the activated carbon rod and the inner filtering barrel.

3. The core module as claimed in claim 2, wherein the base has,
a top surface; and
a lower plug being formed axially on the top surface of the base and protruding into the central channel of the inner filtering barrel; and
the lid has,
a bottom surface; and
an upper plug being formed axially on the bottom surface of the lid, protruding into the central channel of the inner filtering barrel and having a central hole communicating with the central channel of the inner filtering barrel.

4. The core module as claimed in claim 1, wherein the outer filtering barrel is made of non-woven fiber and is pleated.

5. The core module as claimed in claim 3, wherein the outer filtering barrel is made of non-woven fiber and is pleated.

6. The core module as claimed in claim 4, wherein the inner filtering barrel is made of non-woven fiber.

7. The core module as claimed in claim 5, wherein the inner filtering barrel is made of non-woven fiber.

8. The core module as claimed in claim 1, wherein the outer filtering barrel is made of melt-blown.

9. The core module as claimed in claim 3, wherein the outer filtering barrel is made of melt-blown.

10. The core module as claimed in claim 8, wherein the inner filtering barrel is made of melt-blown.

11. The core module as claimed in claim 9, wherein the inner filtering barrel is made of melt-blown.

12. A water filter with a core module as claimed in claim 1, comprising:
a shell being hollow and having a top opening and an inner wall;
the core module being mounted in the shell through the top opening of the shell and having a top end;
an inner cap being mounted on the top end of the core module, being disconnected to the inner wall of the shell to form an interval and having,
a top surface; and
a nozzle being formed axially on the top surface of the inner cap and having,
a central water passage being formed axially through the nozzle and communicating with the central channel of the inner filtering barrel; and
an outer cap being mounted on and covering the top opening of the shell, being mounted around the nozzle of the inner cap and having,
a top surface; and
a connector being hollow, being fonned on the top surface of the outer cap, being mounted around the nozzle and having,
a top end;
a sidewall;
at least one outlet being formed through the sidewall of the connector; and
an inlet being formed through the top end of the connector and communicating with the water passage of the nozzle.

13. The water filter as claimed in claim 12, wherein the water filter further comprising:
a base covering and sealing the bottom ends of the outer filtering barrel, the activated carbon rod and the inner filtering barrel; and
a lid covering the top ends of outer filtering barrel, the activated carbon rod and the inner filtering barrel and corresponding to the top opening of the shell; and
the inner cap covers the lid.

14. The water filter as claimed in claim 13, wherein the base has,
a top surface; and
a lower plug being formed axially on the top surface of the base and protruding into the central channel of the inner filtering barrel;
the lid has,
a bottom surface; and
an upper plug being formed axially on the bottom surface of the lid, protruding into the central channel of the inner filtering barrel and having a central hole communicating with the central channel of the inner filtering barrel;
the nozzle of the inner cap corresponds to the upper plug of the lid; and the central water passage communicates with the central hole of the upper plug.

15. The water filter as claimed in claim 12, wherein the outer filtering barrel is made of non-woven fiber and is pleated.

16. The water filter as claimed in claim 15, wherein the inner filtering barrel is made of non-woven fiber.

17. The water filter as claimed in claim 12, wherein the outer filtering barrel is made of melt-blown.

18. The water filter as claimed in claim 15, wherein the inner filtering barrel is made of melt-blown.

19. A water filter comprising:
a core module for a water filter comprising:
an outer filtering barrel having a top end;
a bottom end; and
a central channel being formed axially through the outer filtering barrel;
an activated carbon rod being mounted in the central channel of the outer filtering barrel and having a top end;
a bottom end; and
a central channel being formed axially through the activated carbon rod; and
an inner filtering barrel being mounted in the central channel of the activated carbon rod and having a top end;
a bottom end; and
a central channel being formed axially through the inner filtering barrel;
wherein said water filter comprises:
a shell being hollow and having a top opening and an inner wall;
the core module being mounted in the shell through the top opening of the shell and having a top end;
an inner cap being mounted on the top end of the core module, being disconnected to the inner wall of the shell to form an interval and having,
a top surface; and
a nozzle being formed axially on the top surface of the inner cap and having,
a central water passage being formed axially through the nozzle and communicating with the central channel of the inner filtering barrel; and
an outer cap being mounted on and covering the top opening of the shell, being mounted around the nozzle of the inner cap and having,
a top surface; and
a connector being hollow, being fonned on the top surface of the outer cap, being mounted around the nozzle and having,
a top end;
a sidewall;
at least one outlet being formed through the sidewall of the connector; and
an inlet being formed through the top end of the connector and communicating with the water passage of the nozzle.
